(19) United States
(12) Patent Application Publication
(10) Pub. No.: US 2026/0204182 A1
(43) Pub. Date: Jul. 16, 2026

(54) CRICOTHYROTOMY MEDICAL TRAINING DEVICE AND METHOD

(71) Applicant: 26 Delta 1 LLC, Dover (DE)

(72) Inventor: Michael H. Volkert, Beverly Hills, CA (US)

(21) Appl. No.: 19/025,127

(22) Filed: Jan. 16, 2025

(51) Int. Cl. G09B 23/30

(52) U.S. Cl. CPC G09B 23/30

(57) ABSTRACT

A cricothyrotomy medical training device includes a ribbed tube representative of a human trachea, the ribbed tube having a first end and a second end. A first protrusion extends from the first end of the ribbed tube, the first protrusion being representative of a human thyroid cartilage. A second protrusion extends from the ribbed tube near the first end, the second protrusion being representative of a human cricoid cartilage. The second protrusion is longitudinally spaced between the first end and the second end. A first marking material is disposed at the first and second protrusions for representing a location of human skin. A second marking material disposed between the first and second protrusions to identify a location of a human cricothyroid membrane.

### FIELD OF THE INVENTION

The present invention relates generally to medical training devices, and more specifically, to a medical training device for performing a cricothyrotomy.

### BACKGROUND OF THE INVENTION

Cricothyrotomy is a critical emergency procedure used to secure an airway when other methods have failed or are not possible, such as in cases of severe airway obstruction, trauma, or swelling. For medical providers, including emergency physicians and paramedics, knowing how to perform a cricothyrotomy can mean the difference between life and death in urgent situations. For military medics and non-medical personnel, particularly those in high-risk environments like combat zones, the ability to perform a cricothyrotomy is equally essential. In austere conditions where immediate medical care may not be available, having the skill to quickly establish an airway can save lives. A need exists for a rugged and portable medical training device for performing a cricothyrotomy that equips medical and non-medical personnel with the training they need to respond effectively to airway emergencies in the field, ensuring that they can provide life-saving care even in the most challenging circumstances.

The current invention addresses these and other needs.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a cricothyrotomy medical training device includes a ribbed tube, a first protrusion, a second protrusion, a first marking material, and a second marking material. The ribbed tube represents a human trachea and has a first end and a second end. The first protrusion extends from the first end of the ribbed tube, the first protrusion being representative of a human thyroid cartilage. The second protrusion extends from the ribbed tube near the first end. The second protrusion is longitudinally spaced between the first end and the second end. The second protrusion represents a human cricoid cartilage. The first marking material is disposed at the first and second protrusions for representing a location of human skin. The second marking material is disposed between the first and second protrusions to identify a location of a human cricothyroid membrane.

According to certain features of the above aspects, the first marking material is in the form of a skin-colored medical gauze.

According to certain features of the above aspects, the first marking material is positioned around the first and second protrusions.

According to certain features of the above aspects, the first marking material is positioned between the first and second protrusions. The first marking material at least partly covers the second marking material.

According to certain features of the above aspects, the second marking material is in the form of a tape material.

According to certain features of the above aspects, the tape material is white.

According to certain features of the above aspects, the second marking material is wrapped around the ribbed tube.

According to certain features of the above aspects, the ribbed tube includes a hole between the first and second protrusions. The hole represents an airway path.

According to certain features of the above aspects, the second marking material covers the hole.

According to certain features of the above aspects, the second protrusion is smaller than the first protrusion.

According to certain features of the above aspects, the cricothyrotomy medical training device also includes a scalpel configured to cut through both the first marking material and the second marking material.

According to certain features of the above aspects, the cricothyrotomy medical training device also includes an endotracheal tube configured for insertion into a hole of the ribbed tube, the hole representing an airway path.

According to certain aspects of the present disclosure, a cricothyrotomy medical training kit includes a ribbed tube, a group of first protrusions, a group of second protrusions, a first material, a second material, a scalpel, and an endotracheal tube. The ribbed tube has a first end and a second end, and a hole near the first end. The group of first protrusions has a first range of sizes. Each first protrusion is configured to attach to and extend from the ribbed tube. The group of second protrusions has a second range of sizes. Each second protrusion corresponds to a respective first protrusion. Each second protrusion is configured to attach to and extend from the ribbed tube, and is longitudinally spaced apart from the first protrusion. The first material is positioned on the first and second protrusions and is indicative of human skin. The second material is positioned on the ribbed tube between the first and second protrusions covering the hole. The second material is indicative of a human cricothyroid membrane. The scalpel is configured to cut through the first and second materials. The endotracheal tube is configured for insertion into the hole, which is accessible after cutting through the first and second materials.

According to certain features of the above aspects, the first range of sizes ranges between a first minimum size and a first maximum size. The first minimum size is about the same size as a human thyroid cartilage, and the first maximum size is larger than the human thyroid cartilage.

According to certain features of the above aspects, the second range of sizes ranges between a second minimum size and a second maximum size. The second minimum size being about the same size as a human cricoid cartilage, and the second maximum size is larger than the human cricoid cartilage.

According to certain aspects of the present disclosure, a method for using a cricothyrotomy medical training device includes preparing the cricothyrotomy medical training device. Preparing the cricothyrotomy medical training device includes attaching a first protrusion at a first end of a ribbed tube, and attaching a second protrusion near the first end of the ribbed tube. The second protrusion is longitudinally separated from the first protrusion by a space along the ribbed tube. Preparing the cricothyrotomy medical training device further includes wrapping a first marking material around the space between the first protrusion and the second protrusion, and wrapping a second marking material over the first marking material and the first and second protrusions. The method for using the cricothyrotomy medical training device further includes locating the space between the first protrusion and the second protrusion, and making an incision through both the first and second marking materials in the space with a scalpel. The method for using the cricothyrotomy medical training device further includes inserting an endotracheal tube into the incision.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a schematic side view of an exemplary cricothyrotomy medical training device, according to certain aspects of the present disclosure.

FIG. 2 is a schematic front view of an exemplary cricothyrotomy medical training device, according to certain aspects of the present disclosure.

FIG. 3 is a schematic front view of an exemplary cricothyrotomy medical training device, showing a layer of a second marking material in a space between first and second protrusions, according to certain aspects of the present disclosure.

FIG. 4 is a schematic side view of a scalpel, according to certain aspects of the present disclosure.

FIG. 5 is a schematic perspective view of an endotracheal tube, according to certain aspects of the present disclosure.

FIG. 6 is a schematic front view of an exemplary cricothyrotomy medical training device, showing an incision made through a layer of a second marking material in a space between first and second protrusions, thereby exposing a hole in the ribbed tubing, according to certain aspects of the present disclosure.

FIG. 7 is a schematic representation of components of a kit for cricothyrotomy medical training, according to certain aspects of the present disclosure.

FIG. 8 is a flow diagram for the steps of a method for using an exemplary cricothyrotomy medical training device, according to certain aspects of the present disclosure.

FIG. 9 is a flow diagram for the steps of a method for using the kit for cricothyrotomy medical training of FIG. 7, according to certain aspects of the present disclosure.

### DETAILED DESCRIPTION

A cricothyrotomy medical training device has a rugged and portable construction including a ribbed tubing and first and second protrusions representative of the human thyroid cartilage and the human cricoid cartilage, respectively, on a human trachea. A space between the first and second protrusions is covered by a white tape representative of a human cricothyroid membrane. A skin-colored gauze covers the first and second protrusions and the white tape.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The current invention includes a cricothyrotomy medical training device and a method for training an operator with the device. Operator errors commonly encountered during cricothyrotomy procedures are addressed. One significant issue is the misidentification of the thyroid and cricoid cartilages. In an embodiment, the cricothyrotomy medical training device incorporates slightly exaggerated anatomical features to serve as landmarks. The use of slightly exaggerated anatomical structures for the thyroid and cricoid cartilage helps non-medical personnel quickly learn to identify these key landmarks, guiding the non-medical personnel to the correct area for incision—the cricothyroid membrane. As users become more comfortable and efficient, these enhanced anatomical structures can be resized and swapped out. In an embodiment a kit having a range of sizes for each of the thyroid and cricoid cartilages is provided, allowing for customizable training and improved skill development.

The cricothyrotomy medical training device disclosed herein is designed to train individuals in the cricothyrotomy emergency airway procedure in the most efficient manner, even in the most austere environments. The rugged construction of the cricothyrotomy medical training device makes it suitable for deployment in the field, while also being practical for use in the safety and security of a controlled setting. The cricothyrotomy medical training device provides a realistic anatomical structure, allowing operators to practice their skills with a life-like experience, ensuring preparedness for real-world emergencies.

A primary advantage of the cricothyrotomy medical training device disclosed herein is its simplicity. The cricothyrotomy medical training device addresses both size and cost concerns that are prevalent in the current market. The cricothyrotomy medical training device is intended to teach both medical and non-medical personnel how to perform a cricothyrotomy. For non-medical individuals who may need to perform this procedure in critical situations, a straightforward and easy-to-use device is essential. Additionally, the compact size allows the cricothyrotomy medical training device to fit into the cargo pocket of the user, for example, a soldier or emergency medical technician (EMT), making it easily portable for those in critical roles. Finally, the cricothyrotomy medical training device disclosed herein is significantly more cost-effective to produce compared to similar devices currently available on the market. By making the device more affordable, it provides a practical way to teach individuals a critical, life-saving procedure.

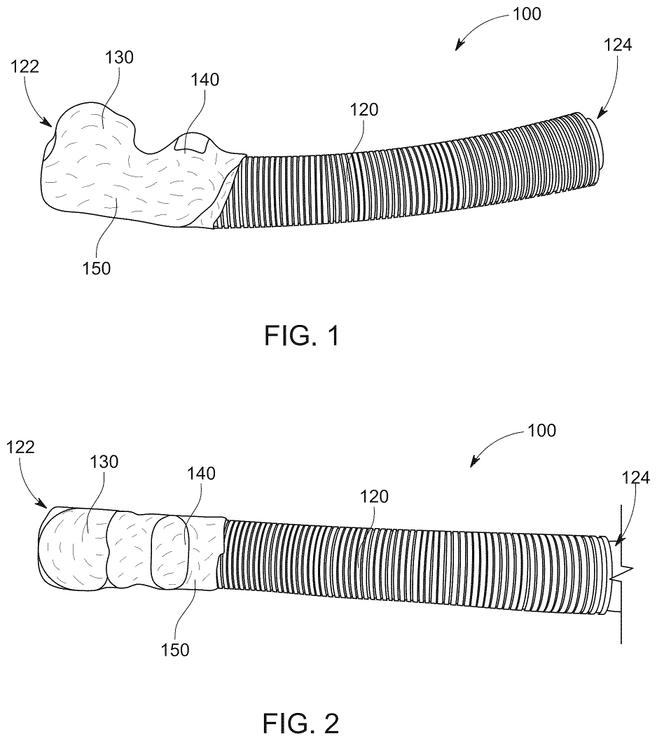

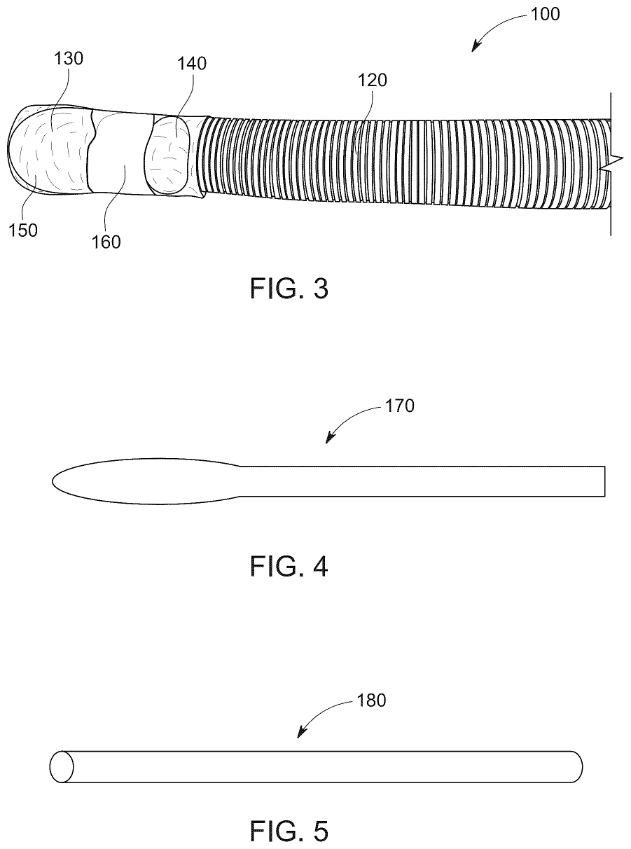

Referring to FIGS. 1 and 2, in an embodiment a cricothyrotomy medical training device 100 includes a ribbed tube 120. The ribbed tube 120 has a first end 122 and a second end 124. A first protrusion 130 extends from the first end 122 of the ribbed tube 120. The first protrusion 130 is representative of a human thyroid cartilage. A second protrusion 140 extends from near the first end 122 of the ribbed tube 120. The second protrusion 140 is longitudinally spaced between the first end 122 and the second end 124, and is representative of a human cricoid cartilage. In an embodiment, the second protrusion 140 is smaller than the first protrusion 130. The ribbed tube 120 is representative of a human trachea, the first protrusion 130 is representative of a human thyroid cartilage, and the second protrusion 140 is representative of a human cricoid cartilage.

Referring to FIG. 3, in an embodiment a first marking material 150, for example without limitation, skin-colored medical gauze 150, is disposed around the first and second protrusions 130, 140. The skin-colored medical gauze 150 is representative of human skin. In an embodiment, a second marking material 160, for example without limitation, white tape 160, is disposed around the ribbed tube 120 between the first and second protrusions 130, 140. The white tape 160 is representative of a human cricothyroid membrane. The first marking material 150 is further disposed between the first and second protrusions 130, 140 and covering the second marking material 160.

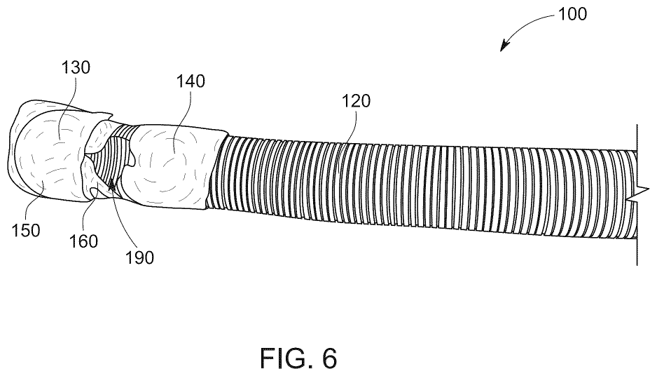

In an embodiment, the second marking material 160 is disposed over a hole 190 (see FIG. 6) in the ribbed tube 120. The hole 190 is disposed through a wall of the ribbed tube 120 between the first and second protrusions 130, 140. The hole 190 represents an airway path. Referring to FIGS. 4 and 5, the cricothyrotomy medical training device 100 further includes a scalpel 170 and an endotracheal tube 180. The scalpel 170 is configured to cut through both the first marking material 150 and the second marking material 160. The endotracheal tube 180 is configured for insertion into the hole 190 of the ribbed tube 120. In an embodiment, the ribbed tube 120 is about 9 inches long with a circumference of about 4 inches, designed to represent a human trachea. The first and second protrusions 130, 140 are positioned on the ribbed tube 120 to simulate the human thyroid and cricoid cartilages.

Referring to FIG. 6, a small incision in the second marking material 160, illustrated as white tape 160, using the scalpel 170 (FIG. 4) allows an operator to insert an endotracheal tube 180 (FIG. 5) into the exposed hole 190 in the ribbed tube 120, mimicking the process of a real-world cricothyrotomy. The second marking material 160 (see also FIG. 3) covers the hole 190, representing the human cricothyroid membrane. Additionally, the first marking material 150, illustrated by the skin-colored medical gauze 150, is layered over the first and second protrusions 130, 140 and the first marking material 160, simulating human skin. The skin-colored medical gauze 150 is easy to cut through, providing a realistic experience for the operator when using the scalpel 170. Cutting through the “skin” represented by the skin-colored medical gauze 150 exposes the white tape 160, which represents the human cricothyroid membrane. Further cutting through the white tape 160 exposes the hole 190, where the operator places the endotracheal tube 180.

Without the cricothyrotomy medical training device 100, the next best alternative for cricothyrotomy training is using a human cadaver, which is a highly expensive and difficult resource to access outside of medical school. The current customer profile for the cricothyrotomy medical training device 100 includes emergency medical professionals, such as attending physicians, medical residents, medical students, EMT-Paramedics, military medics, and non-medical military personnel serving in combat arms positions.

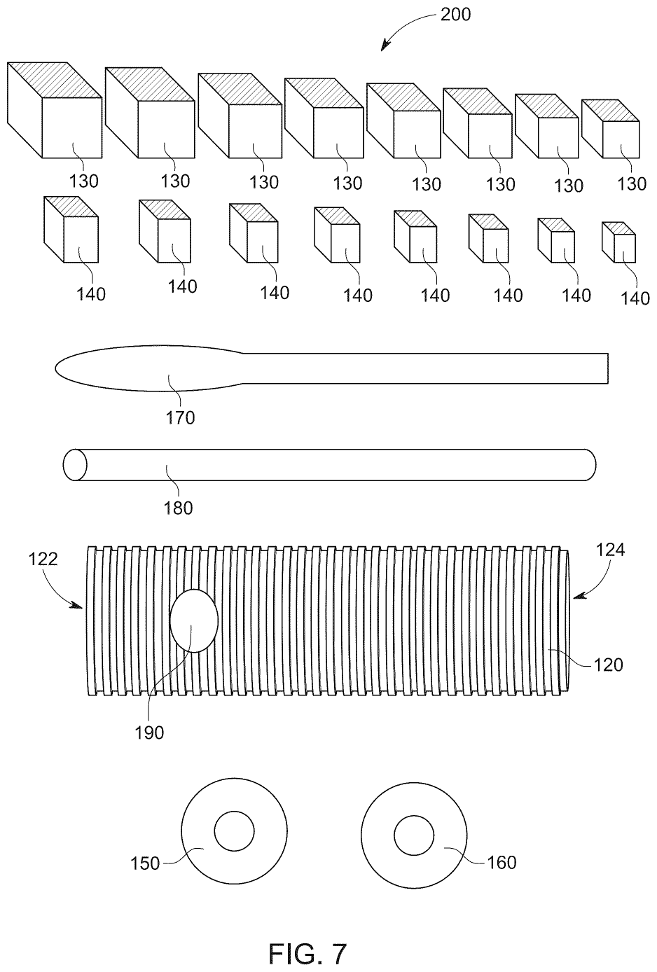

Referring to FIG. 7, in an embodiment, a kit 200 for cricothyrotomy medical training includes a set of supplies sufficient to make a plurality of cricothyrotomy medical training devices 100 as described hereinabove in regard to FIGS. 1-6. For example, kit 200 includes a ribbed tube 120, a plurality of first protrusions 130, and a plurality of second protrusions 140. The kit 200 further includes a supply of the first marking material 150, for example a roll of skin-colored medical gauze 150, and a supply of the second marking material 160, for example a roll of white tape 160. The kit 200 further includes a scalpel 170, and an endotracheal tube 180. In an embodiment the plurality of first protrusions 130 has a first range of sizes as shown going from larger to smaller left to right in FIG. 7. Likewise, the plurality of second protrusions 140 has a second range of sizes as shown going from larger to smaller left to right in FIG. 7. Each second protrusion 140 of the plurality of second protrusions 140 corresponds to a respective first protrusion 130 of the plurality of first protrusions 130. The ribbed tube 120 has a first end 122 and a second end 124 and a hole 190 near the first end.

Each of the first and second protrusions 130, 140 in FIG. 7 is configured to attach to and extend from the ribbed tube 120. Attachment can be via an adhesive pre-applied to one side of each of the first and second protrusions 130, 140, via an additional roll of adhesive tape (not shown), or via simply being held in place on the ribbed tubing by the flesh-colored medical gauze that is wrapped around both of the first and second protrusions 130, 140. Each second protrusion 140 is configured to attach to the ribbed tube 120 longitudinally spaced apart from each respective first protrusion 30.

Each of the plurality of second protrusions 140 shown in the progression of sizes going from left to right in FIG. 7 corresponds to one of the plurality of first protrusions 130 shown in the progression of sizes going from left to right in FIG. 7. The first range of sizes of the plurality of first protrusions 130 ranges from a first maximum size that is larger than a human thyroid cartilage at the far left of FIG. 7 to a first minimum size that is about the same size as a human thyroid cartilage at the far right of FIG. 7. Similarly, the second range of sizes of the plurality of second protrusions 140 ranges from a second maximum size that is larger than a human cricoid cartilage at the far left of FIG. 7 to a second minimum size that is about the same size as a human cricoid cartilage at the far right of FIG. 7.

The kit 200 can be used to help improve an operator's skill in performing a cricothyrotomy by repeatedly performing cricothyrotomies using the cricothyrotomy medical training device 100 having the same size first and second protrusions 130, 140 or successively smaller first and second protrusions 130, 140. After an operator becomes more comfortable and efficient in performing a cricothyrotomy for a given size of thyroid and cricoid cartilages represented respectively by the first and second protrusions 130, 140, the first and second protrusions 130, 140 can be swapped out and made smaller.

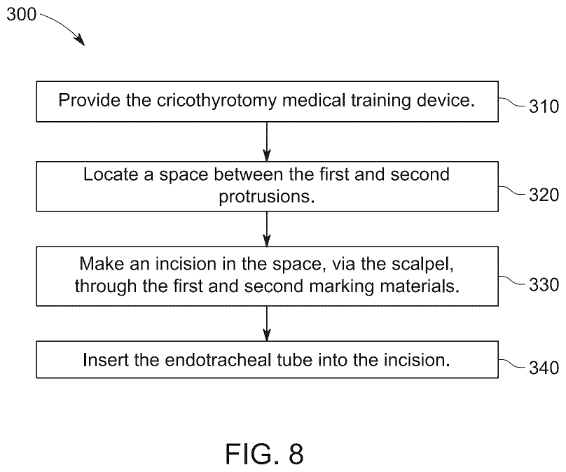

Referring to FIG. 8, a method 300 for using the cricothyrotomy medical training device 100 to train an operator is presented. The method starts at step 310 by providing the cricothyrotomy medical training device 100. At step 320, the operator locates a space between the first and second protrusions 130, 140. At step 330, the operator makes an incision in the space, via the scalpel 170, through the first marking material 150 and the second marking material 160. At step 340 the operator inserts the endotracheal tube 180 into the incision. Steps 310-340 of the method 300 are the basic training steps that an operator needs to master. As noted, once the operator masters the basic training steps for given sized first and second protrusions 130, 140, the cricothyrotomy medical training device 100 can be reconfigured with smaller first and second protrusions 130, 140 for more training.

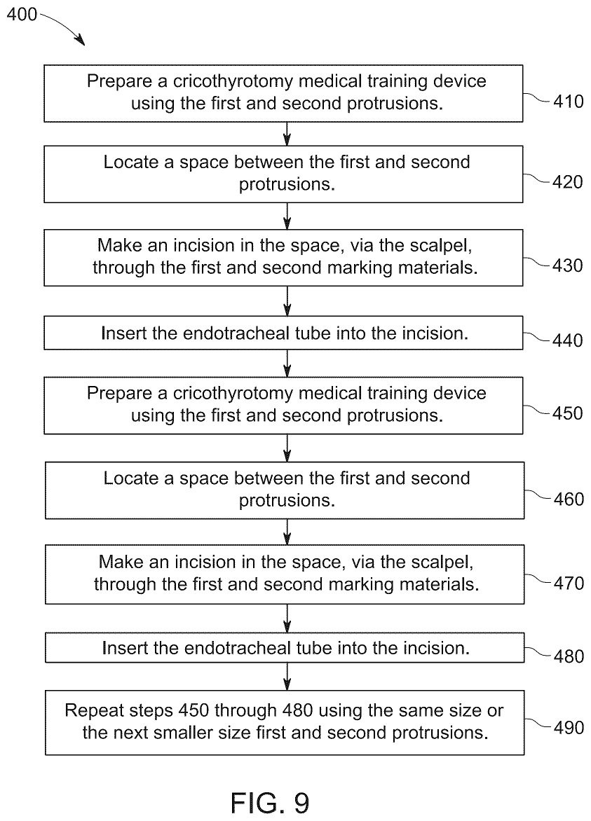

In this context, an extended method 400 for using the kit 200 is shown in FIG. 9. At step 410 a cricothyrotomy medical training device 100 is prepared using the first and second protrusions 130, 140 of any desired size. In an embodiment of the method 400, the first and second protrusions 130, 140 in step 410 can be the largest first and second protrusions 130, 140 of the pluralities of first and second protrusions 130, 140 in the kit 200. However, in other embodiments, the step 410 can utilize first and second protrusions 130, 140 that are other than the largest first and second protrusions 130, 140.

Preparation of the cricothyrotomy medical training device 100 proceeds by attaching the first protrusion 130 at a first end of the ribbed tube 120, and attaching the second protrusion 140 near the first end of the ribbed tube 120. The second protrusion 140 is longitudinally separated from the first protrusion 130 by a space. Further steps in the preparation of the cricothyrotomy medical training device 100 include wrapping the second marking material 160, for example, the white tape 160, around the space, and wrapping the first marking material 150, for example, the skin-colored medical gauze 150, around the first protrusion 130, the second protrusion 140, and the second marking material 160.

With the cricothyrotomy medical training device 100 thus prepared from the kit 200, the method 400 continues at step 420, where the operator locates the space between the first protrusion 130 and the second protrusion 140. At step 430, the operator makes an incision in the space, via the scalpel 170, through the first marking material 150 and the second marking material 160. At step 440, the operator inserts the endotracheal tube 180 into the incision.

The cricothyrotomy medical training device 100 can be thus prepared and used to train an operator as many times as needed for the operator to feel comfortable with a given size of first and second protrusions 130, 140. For example, by using the kit 200, the cricothyrotomy medical training device 100 can be reconstituted or restored from a post-operative state back to a pre-operative state, for example, by wrapping a fresh layer of the second marking material 160 around the ribbed tube 120 and over the hole 190, and then subsequently wrapping a fresh layer of the first marking material 150 over the first and second protrusions 130, 140 and the second marking material 160. Advantageously, depending on the improvement of an operator's developed level of skill in performing the cricothyrotomy, the kit 200 can be used to reconstitute the cricothyrotomy medical training device 100 with either the same size or successively smaller first and second protrusions 130, 140.

In that context, referring again to FIG. 9, at step 450 the cricothyrotomy medical training device 100 is again prepared using the same size or the next smaller first and second protrusions 130, 140 in the kit 200. If the operator has not yet mastered the cricothyrotomy procedure (for example, the method 300) then the first and second protrusions 130, 140 would likely be kept the same size. However, if the operator has mastered the cricothyrotomy procedure with the current sized first and second protrusions 130, 140, then the next smaller first and second protrusions 130, 140 can be used to further the operator's training. Preparation of the cricothyrotomy medical training device 100 in step 450 continues, for example, by attaching the next smaller first protrusion 130 to the ribbed tube 120, and attaching the next smaller second protrusion 140 to the ribbed tube 120, wherein the next smaller second protrusion 140 is separated from the next smaller first protrusion 130 by a space. Further steps in the preparation of the cricothyrotomy medical training device 100 include wrapping the second marking material 160 around the space, and wrapping the first marking material 150 around the first protrusion 130, the second protrusion 140, and the second marking material 160.

With the cricothyrotomy medical training device 100 again thus prepared, the method 400 continues at step 460, where the operator locates the space between the first protrusion 130 and the second protrusion 140. At step 470, the operator makes an incision in the space, via the scalpel 170, through the first marking material 150 and the second marking material 160. At step 480, the operator inserts the endotracheal tube 180 into the incision. At step 490, if the operator has not mastered the cricothyrotomy procedure using the current sizes of the first and second protrusions 130, 140, then step 450 is repeated with the same size first and second protrusions 130, 140. However, upon achieving a level of mastery of the cricothyrotomy procedure for the current sizes of the first and second protrusions 130, 140, at step 490 the operator repeats steps 450 through 480 for successive cricothyrotomy medical training devices 100 having the next smaller first and second protrusions 130, 140.

It is foreseeable that a next generation of the cricothyrotomy medical training device 100 will incorporate AI-assisted technology to guide operators through the cricothyrotomy procedure. This AI-enabled platform will transform the medical training device into an interactive, hand-held software application. Operators will be able to engage with the procedure using reality-based technology displayed on a screen, enhancing both training efficiency and effectiveness.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A cricothyrotomy medical training device comprising:
a ribbed tube representative of a human trachea, the ribbed tube having a first end and a second end;
a first protrusion extending from the first end of the ribbed tube, the first protrusion being representative of a human thyroid cartilage;
a second protrusion extending from the ribbed tube near the first end, the second protrusion being longitudinally spaced between the first end and the second end, the second protrusion being representative of a human cricoid cartilage;
a first marking material disposed at the first and second protrusions for representing a location of human skin; and
a second marking material disposed between the first and second protrusions to identify a location of a human cricothyroid membrane.

2. The cricothyrotomy medical training device of claim 1, wherein the first marking material is in the form of a skin-colored medical gauze.

3. The cricothyrotomy medical training device of claim 1, wherein the first marking material is disposed around the first and second protrusions.

4. The cricothyrotomy medical training device of claim 1, wherein the first marking material is disposed between the first and second protrusions, the first marking material covering in part the second marking material.

5. The cricothyrotomy medical training device of claim 1, wherein the second marking material is in the form of a tape material.

6. The cricothyrotomy medical training device of claim 5, wherein the tape material is white.

7. The cricothyrotomy medical training device of claim 1, wherein the second marking material is wrapped around the ribbed tube.

8. The cricothyrotomy medical training device of claim 1, wherein the ribbed tube includes a hole between the first and second protrusions, the hole representing an airway path.

9. The cricothyrotomy medical training device of claim 8, wherein the second marking material covers the hole.

10. The cricothyrotomy medical training device of claim 1, wherein the second protrusion is smaller than the first protrusion.

11. The cricothyrotomy medical training device of claim 1, further comprising a scalpel configured to cut through both the first marking material and the second marking material.

12. The cricothyrotomy medical training device of claim 4, further comprising an endotracheal tube configured for insertion into a hole of the ribbed tube, the hole representing an airway path.

13. A cricothyrotomy medical training kit, comprising:
a ribbed tube having a first end and a second end, the ribbed tube further having a hole near the first end;
a plurality of first protrusions having a first range of sizes, each first protrusion of the plurality of first protrusions being configured to attachably extend from the ribbed tube;
a plurality of second protrusions having a second range of sizes, each second protrusion of the plurality of second protrusions corresponding to a respective first protrusion of the plurality of first protrusions, each second protrusion being configured to attachably extend from the ribbed tube, each second protrusion being longitudinally spaced apart from the first protrusion;
a first material disposed at respectively attached first and second protrusions, the first material being indicative of human skin;
a second material disposed on the ribbed tube between the respectively attached first and second protrusions, the second material being indicative of a human cricothyroid membrane, the second material covering the hole;
a scalpel configured to cut through the first and second materials; and
an endotracheal tube configured for insertion into the hole, the hole being accessible after cutting through the first and second materials.

14. The cricothyrotomy medical training kit of claim 13, wherein the first range of sizes ranges between a first minimum size and a first maximum size, the first minimum size being about the same size as a human thyroid cartilage, the first maximum size being larger than the human thyroid cartilage.

15. The cricothyrotomy medical training kit of claim 13, wherein the second range of sizes ranges between a second minimum size and a second maximum size, the second minimum size being about the same size as a human cricoid cartilage, the second maximum size being larger than the human cricoid cartilage.

16. A method for using a cricothyrotomy medical training device, the method comprising:
preparing the cricothyrotomy medical training device by
attaching a first protrusion at a first end of a ribbed tube,
attaching a second protrusion near the first end of the ribbed tube, the second protrusion being longitudinally separated from the first protrusion by a space along the ribbed tube,
wrapping a first marking material around the first protrusion and the second protrusion,
wrapping a second marking material around the space, the second marking material being wrapped over the first marking material;
locating the space between the first protrusion and the second protrusion;
making an incision in the space, via a scalpel, through both the first and second marking materials; and
inserting an endotracheal tube into the incision.
